(19) United States
(12) Patent Application Publication
(10) Pub. No.: US 2014/0067686 A1
(43) Pub. Date: Mar. 6, 2014

(54) Pre-Downloading Digital Content to Client Devices

(71) Applicants: Thomas James Tuttle, Somerville, MA (US); Zhen Elizabeth Fong-Jones, Somerville, MA (US)

(72) Inventors: Thomas James Tuttle, Somerville, MA (US); Zhen Elizabeth Fong-Jones, Somerville, MA (US)

(73) Assignee: GOOGLE INC., Mountain View, CA (US)

(21) Appl. No.: 13/597,619

(22) Filed: Aug. 29, 2012

(51) Int. Cl. G06Q 30/00; G06F 21/00; G06F 15/16

(52) U.S. Cl. 705/51; 705/26.1

(57) ABSTRACT

Content is pre-downloaded to a client device used by user. The pre-downloaded content is received and stored at the client device and has an access restriction to prevent the user from consuming the pre-downloaded content. The client device interacts with the user to facilitate purchase transactions for the pre-downloaded content. After the pre-downloaded content is purchased, the client device removes the access restriction to allow the user to consume the pre-downloaded content on the client device. Pre-downloading digital content allows the user, for example, to access the pre-downloaded content without needing to download the content at the time of purchase.

### BACKGROUND

1. Technical Field

This disclosure relates generally to pre-downloading content to an ebook reader or other electronic device.

2. Background

Electronic books (ebooks) are becoming very popular. Ebooks can be conveniently purchased online and subsequently downloaded to ebook readers or other client devices for users to access. Other content, such as newspapers, magazines, music, and videos, are undergoing the same shift to digital form and enjoy the same benefits.

Digital content is downloaded to a client device from a repository. Often, the repository is remote from the client device and accessed via a network. A user is unable to add content to the device if the repository is inaccessible. For example, a user who finishes reading an eBook might wish to obtain a new ebook but find that doing so is impossible because no network connection is available.

### SUMMARY

A method, non-transitory computer-readable storage medium, and system for pre-downloading content to a client device used by user are described herein. One aspect of the method comprises receiving pre-downloaded content at the client device via a network, the pre-downloaded content stored at the client device and having an access restriction preventing the user from consuming the pre-downloaded content. The method further comprises interacting with the user of the client device to facilitate a purchase transaction for the content pre-downloaded to the client device. The method additionally comprises, responsive to the purchase transaction, removing the access restriction to allow the user to consume the pre-downloaded content at the client.

One aspect of the non-transitory computer-readable storage medium stores executable computer program instructions for pre-downloading content to a client device used by user. The computer program instructions comprise instructions for receiving pre-downloaded content at the client device via a network, the pre-downloaded content stored at the client device and having an access restriction preventing the user from consuming the pre-downloaded content. The computer program instructions further comprises interacting with the user of the client device to facilitate a purchase transaction for the content pre-downloaded to the client device. The computer program instructions additionally comprises, responsive to the purchase transaction, removing the access restriction to allow the user to consume the pre-downloaded content at the client.

One aspect of the computer system for identifying pre-downloading content to a client device used by user comprises a non-transitory computer readable storage medium storing executable program code. The executable program code comprises code for receiving pre-downloaded content at the client device via a network, the pre-downloaded content stored at the client device and having an access restriction preventing the user from consuming the pre-downloaded content. The executable program code further comprises interacting with the user of the client device to facilitate a purchase transaction for the content pre-downloaded to the client device. The executable program code additionally comprises, responsive to the purchase transaction, removing the access restriction to allow the user to consume the pre-downloaded content at the client.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE FIGURES

FIG. 1 is a high-level block diagram of a communications environment for pre-downloading digital content to client devices.

FIG. 2A illustrates an example of the client device GUI showing a user's ebook library in a list view.

FIG. 2B illustrates an example of the client device GUI showing the same user's ebook library in a bookshelf view.

FIG. 3 is a high-level block diagram of a computer for use as the client devices, content server, and/or other entity illustrated in the communications environment shown in FIG. 1.

FIG. 4 is a block diagram illustrating modules within an exemplary architecture of the pre-download manager of a client device according to one embodiment.

FIG. 5 is a flowchart illustrating a method of providing access to pre-downloaded content according to one embodiment.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures and may indicate similar or like functionality.

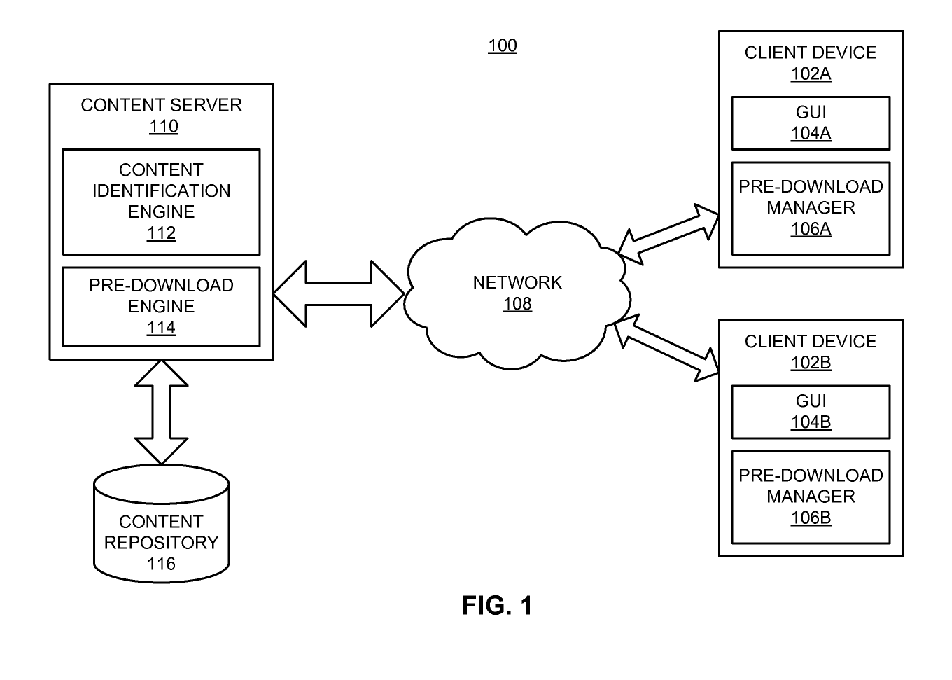

FIG. 1 is a high-level block diagram of a communications environment 100 for pre-downloading digital content to client devices. The environment 100 includes multiple client devices 102 (depicted by way of example in FIG. 1 as client devices 102A and 102B), a content server 110, a content repository 116, and a network 108. The network 108 is a data communications network and in one embodiment includes the Internet.

Generally, a user can download electronic books (ebooks) or other digital content to a client device 102. To download the content, the client device 102 sends a request for the content to the content server 110 via the network 108. The content server 110 obtains a copy of the requested content from the content repository 116 and transmits it to the client device 102. After the client device 102 finishes downloading, the user can consume the content. The digital content includes but is not limited to media content such as: ebooks, magazines and newspapers, music, videos, and software applications. By way of example and for ease of discussion, the following discussion assumes ebooks are the digital content that the user consumes.

In one embodiment, the client devices 102 are electronic devices used by users to read ebooks. For example, the client devices 102 can be dedicated ebook readers or other general or specific-purpose computing devices such as mobile telephones, or tablet, notebook, or desktop computers executing ebook reading applications. The ebook reading applications can be standalone applications or integrated into operating systems, web browsers or other software executing on the computing devices. While only two client devices 102A, 102B are illustrated in FIG. 1, the environment 100 may include thousands or millions of such devices, as well as multiple content servers 110 and/or other entities.

A client device 102 and/or ebook reading application executing on the client device provides a graphic user interface (GUI) 104 (depicted by way of example in FIG. 1 as GUI 104A corresponding to client device 102A and GUI 104B corresponding to client device 102B) that a user may use to view content available on the device, obtain content via the network 108, read ebooks and other content, and perform various other functions. To obtain ebooks and other content via the network 108, the GUI may allow the user to interact with the content server 110 to browse content stored in the content repository 116.

In one embodiment, the client device 102 also includes a pre-download manager 106 that pre-downloads content, for example, content that the user has not purchased, specifically subscribed to, or otherwise explicitly expressed interest in obtaining from the content server 110. The client device 102 has more storage capacity than is used by typical users, and the pre-download manager 106 uses this excess capacity to pre-download content in which the user may be interested. The pre-downloaded content may be selected based on characteristics of the user such as the user's downloading, purchasing, and reading histories. For example, the pre-download manager 106 may pre-download ebooks recommended based on other ebooks the user has read. Moreover, the pre-downloaded ebooks may include entire ebooks and/or samples of portions of ebooks that are available for purchase, such as an abstract or an introductory chapter.

The pre-download manager 106 may restrict access to the pre-downloaded content so that the user cannot access the content without purchasing it or performing another action. Pre-downloading ebooks and/or other content can reduce the time between the user ordering the content and having the content available on the client device 102. It may also allow the user to purchase the content when network connectivity with the content server 110 is limited or unavailable.

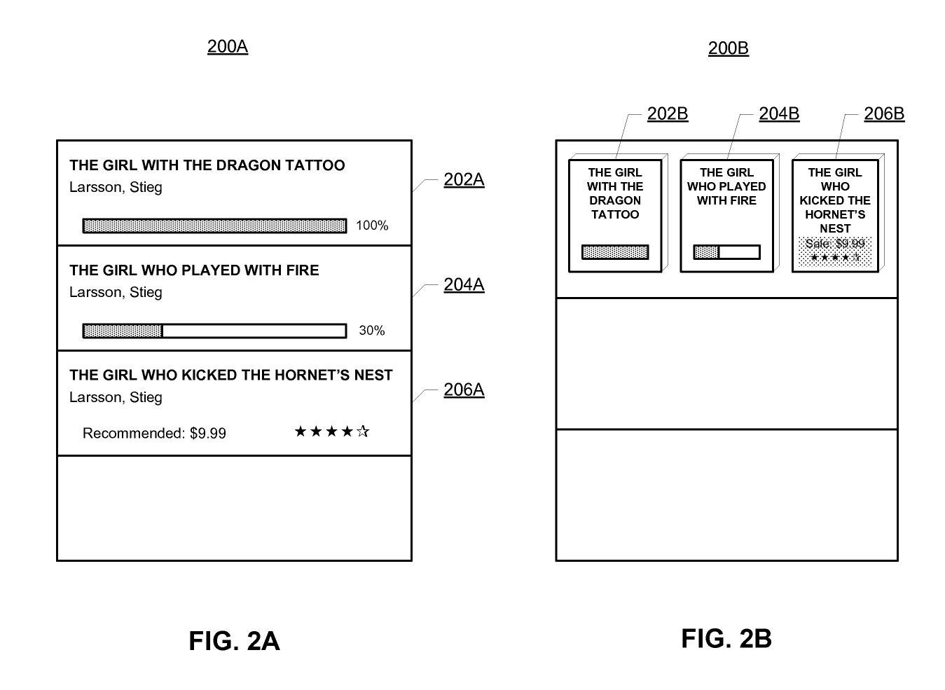

The GUI of the client device 102 may illustrate the pre-downloaded ebooks as well as other content downloaded to the client device 102. FIG. 2A illustrates an example of the client device GUI 200A showing a user's ebook library in a list view. The top of the list displays a first ebook 202 in a book series with a reading progress bar showing 100%, indicating that the user has finished reading the book. A second ebook 204 in the same series is displayed in the middle of the list, which the user is currently reading and has finished 30% of the ebook as indicated by the reading progress bar. A third ebook 206 displayed at the end of the list is the last ebook in the series, which the client device 102 has pre-downloaded even though the user has not purchased it. Hence, the GUI 200A shows promotional information informing the user of the pre-download and/or enticing the user to purchase the third ebook 206. The promotional information visually distinguishes the pre-downloaded book from books purchased or intentionally downloaded by the user. In the illustrated GUI 200A, the promotional information includes a price for the ebook ($9.99) and rating information (4 of 5 possible stars).

FIG. 2B illustrates an example of the client device GUI 200B showing the same user's ebook library in a bookshelf view. In this view, the covers of the ebooks are presented as if the ebooks were physical books facing outward on a bookshelf. The GUI 200B shows the third, pre-downloaded ebook 206B displayed alongside the other ebooks 202B, 204B. The promotional information in this GUI 200B is presented as a virtual sticker on the cover of the third ebook 206. Other embodiments use different types of user interfaces, visually distinguish pre-downloaded ebooks in other ways, and/or present different information about pre-downloaded ebooks.

Returning to FIG. 1, the content server 110 comprises one or more computers and provides ebooks and/or other digital content to client devices 102 via the network 108. The content server 110 may include a front end, such as a website of the online store, through which users can browse, search, and purchase content. The content server 110 may interact with the client devices 102 to provide additional features such as cloud access to content, synchronizing content across multiple devices, and sharing content with other devices and/or users.

In one embodiment, the content server 110 includes a content identification engine 112 for identifying content to pre-download to client devices 102. As mentioned above, the content identification engine 112 may identify ebooks and other content to pre-download based on characteristics of the user. These characteristics may include preferences indicated by the user, such as preferences implicitly indicated by the users' behaviors and preferences explicitly indicated by the users. For example, the content identification engine 112 may observe that the user has purchased two of three ebooks in a series, and thus identify the third ebook in the series for pre-downloading to the user's client device 102. In another example, a user may respond to a survey by indicating the user enjoys reading a certain type of ebook. In this case the content identification engine 112 may then identify ebooks of that type for pre-downloading to the user's client device 102.

The content identification engine 112 may also identify content to pre-download based on characteristics of the content. For example, the content identification engine 112 may identify ebooks to pre-download from among lists of bestsellers and/or popular ebooks. Furthermore, the content identification engine 112 may identify content to pre-download to a user based on characteristics of other users, such as users connected to the user through a social network.

Embodiments of the content identification engine 112 may use combinations of the various techniques described above to identify content for pre-downloading. Since the identified content represents content in which a user may be interested, the content is referred to as being “recommended” to the user. Further, embodiments of the content identification engine 112 may use different and/or additional techniques to identify the recommended content.

The content identification engine 112 may rank the identified content in an order based on one or more of a variety of factors. In one embodiment, the highest-ranked content is that that the content identification engine 112 identifies as having the highest likelihood of being purchased by the user. The rankings may be influenced by the content the user is currently consuming and/or has recently consumed. For example, a ranking of the ebooks identified for a user from top to bottom may be: next ebook or ebooks in the same series as the ebook that the user is currently reading, ebooks by the same author(s) as the ebook that the user is currently reading, popular ebooks of the same genre as the book that the user is currently reading, and other bestselling ebooks.

In one embodiment, the content server 110 also includes a pre-download engine 114 for sending recommended pre-download content to the client devices 102. In one embodiment, the pre-download engine 110 interacts with the content identification engine 112 to obtain a ranked list of content identified for a user. In addition, the pre-download engine 110 interacts with the pre-download manager 106 of that user's client device 102 to send content in the list to the client device. This latter interaction may include pushing listed content to the client device 102 as pre-downloaded content and/or sending listed content in response to requests from the pre-download manager 106 of the client device.

In one embodiment, the pre-download engine 114 restricts access to the pre-downloaded content to prevent the user from consuming the content until the user purchases or otherwise obtains legitimate access to the content. For example, the pre-download engine 114 may encrypt or otherwise obfuscate a pre-downloaded ebook using one or more encryption keys. The pre-download engine 114 may forward a corresponding decryption key to the client device 102 that allows the device to decrypt the pre-downloaded ebook after the user purchases it.

The content repository 116 is in communication with the content server 110 and includes a database storing ebooks and/or other digital content. Depending upon the embodiment, the content repository 116 includes a relational or other type of database. The database may be local to or remote from the content server 110. The ebooks in the repository 116 include text, images, and/or other content that form the ebooks. In addition, each ebook may have associated metadata that describe the ebook, such as describing the ebook's title, author, publication date, publisher, language, International Standard Book Number (ISBN), etc. The information in the content repository 116 may also store other information, such as encryption keys used to encrypt content, information indicating what content has been pre-downloaded to which client devices 102, etc.

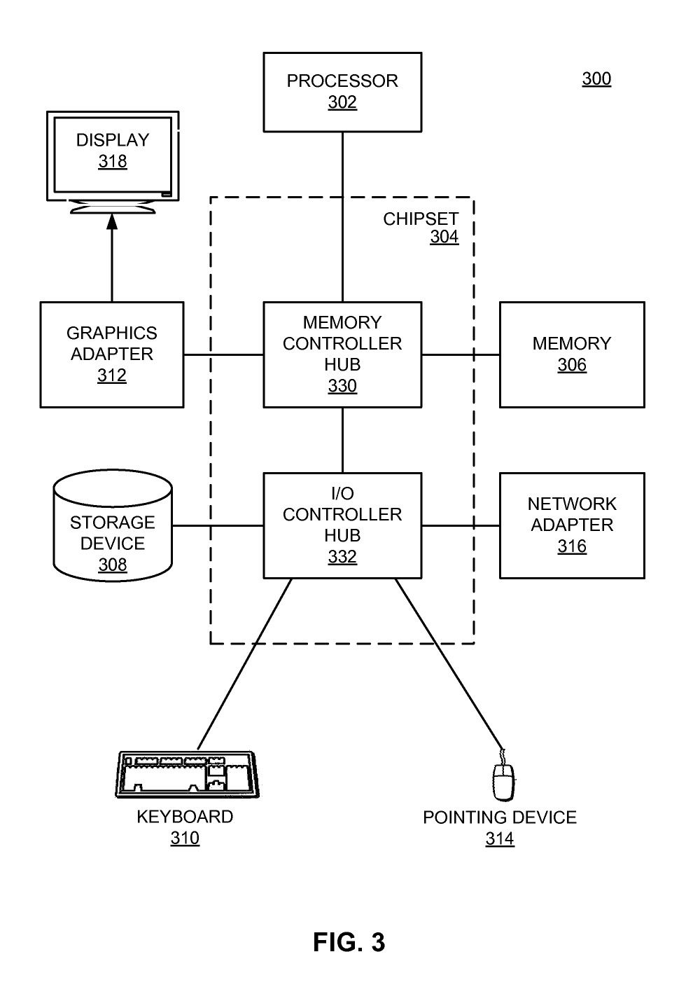

FIG. 3 is a high-level block diagram of a computer 300 for use as the client devices 102, content server 110, and/or other entities illustrated in the communications environment 100 shown in FIG. 1. Illustrated are at least one processor 302 coupled to a chipset 304. The chipset 304 includes a memory controller hub 320 and an input/output (I/O) controller hub 322. A memory 306 and a graphics adapter 312 are coupled to the memory controller hub 320, and a display device 318 is coupled to the graphics adapter 312. A storage device 308, keyboard 310, pointing device 314, and network adapter 316 are coupled to the I/O controller hub 322. Other embodiments of the computer 300 have different architectures. For example, the memory 306 is directly coupled to the processor 302 in some embodiments.

The storage device 308 is a non-transitory computer-readable storage medium such as a hard drive, compact disk read-only memory (CD-ROM), DVD, or a solid-state memory device. The memory 306 holds instructions and data used by the processor 302. The pointing device 314 is a mouse, track ball, or other type of pointing device, and is used in combination with the keyboard 310 to input data into the computer 300. The graphics adapter 312 displays images and other information on the display device 318. The network adapter 316 couples the computer 300 to a network. Some embodiments of the computer 300 have different and/or other components than those shown in FIG. 3. The types of computer 300 can vary depending upon the embodiment and the desired processing power.

The computer 300 may comprise multiple blade servers working together to provide the functionality described herein.

The computer 300 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 308, loaded into the memory 306, and executed by the processor 302. A collection of one or more modules may be referred to herein as an “engine” or “manager.”

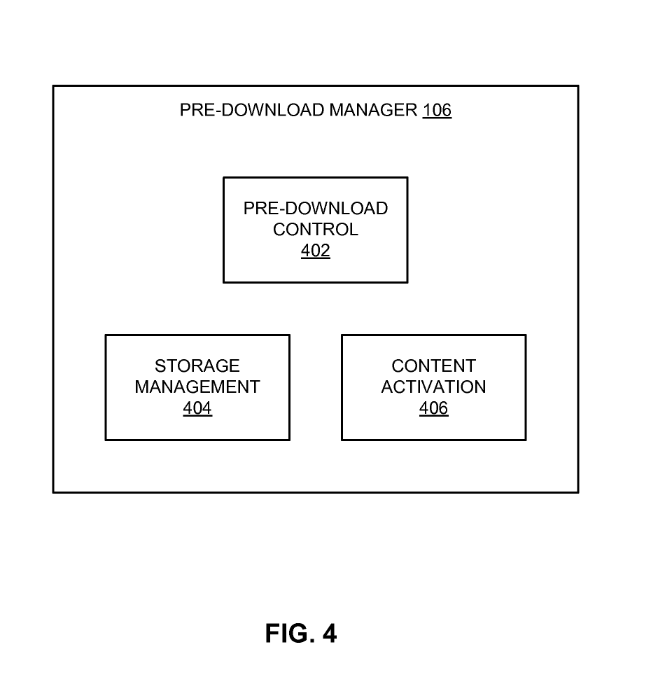

FIG. 4 is a block diagram illustrating modules within an exemplary architecture of the pre-download manager 106 of a client device 102 according to one embodiment. The pre-downloading manager 106 includes a pre-download control module 402, a storage management module 404, and a content activation module 406. Other embodiments may include different or additional modules. Likewise, the modules may perform different or additional functions in some embodiments.

The pre-download control module 402 interacts with the pre-download engine 114 of the content server 110 to pre-download content. As mentioned above, the pre-downloading may be initiated by the client device 102 or by the content server 110. To this end, the pre-download control module 402 may contact the control server 110 to pull recommended content from the control server 110. Likewise, the pre-download control module 402 may receive communications initiated by the content server 110 that push content to the client device 102. Activation of the pre-download control module 402 may be controlled by user-selected preferences. For example, the user of the client device 102 may configure the client device to subscribe to pushed pre-downloads from the content server 110 and/or may configure the client device to request pulled content from the content server.

In one embodiment, the pre-download control module 402 schedules occurrences of content pre-downloading to the client device 102. The scheduling is based on scheduling conditions such as time, date, status of the client device 102, and attributes of the client device. For example, the scheduling conditions may include the battery level, free storage space, usage level, and connectivity status of the client device 102. The pre-download control module 402 evaluates the scheduling conditions and schedules a time to pull (retrieve) content from the content server 110. For example, the pre-download control module 402 may schedule pre-downloading for a time when the battery of the client device 102 has sufficient charge to perform the pre-loading, the client device 102 has sufficient storage space to store pre-downloaded content, pre-downloading will not interfere with the user's activities given the usage level of the client device, and the client device has sufficient network connectivity to support pre-downloading. The scheduled time may be at a designated date and time subsequent to the evaluation, or may be contemporaneously with when the scheduling conditions are evaluated. The pre-download control module 402 may establish a schedule that pulls pre-downloaded content from the content server 110 when the client device 102 is downloading purchased content from the content server 110, when the client device 102 is synchronizing data with another device, or at other times. The content server 110 may perform a similar evaluation of scheduling conditions to schedule times to push content to the client device 102.

The pre-download control module 402 interacts with the content identification engine 112 to determine the amount of content and the specific content to pre-download. In one embodiment, the pre-download control module 402 provides information to the content identification engine 112 that the engine uses to select the content to provide to the client device 102. This information may describe, e.g., characteristics of the user of the client device 102, characteristics of content downloaded to the client device, and/or characteristics of the client device such as the amount of space available to store pre-downloaded content at the client device. In other embodiments, the content identification engine 112 provides the pre-download control module 402 with information describing content available for pre-download, and the pre-download control module automatically selects content to pre-download to the client device 102. For example, content identification engine 112 may select ebooks from a ranked list of ebooks for the user of the client device to pre-download. Similarly, the pre-download control module 402 may receive a list of recommended ebooks from the content identification engine 112 and select books from the list to pre-download.

The storage management module 404 manages storage for pre-downloaded content at the client device 102. The storage device 308 of the client device 102 stores a limited amount of data, although the specific size of the storage device may vary in different embodiments. In one embodiment, the storage management module 404 specifies an upper limit of the available storage space that may be consumed by pre-downloaded content. The upper limit may be specified as a percentage of the total storage space, by an absolute amount, by a number of ebooks, and/or by using other techniques. For example, the maximum space allocated for pre-downloading can be set at 25% of the total storage space on the client device 102, to a 512 MB limit, and/or to 10 ebook titles.

The storage management module 404 can delete pre-downloaded content from the client device 102 and may delete such content for a variety of reasons. For example, the storage management module 404 may delete one or more ebooks to make room for new content purchased or otherwise downloaded by the user. The storage management module 404 may also delete content to make room for new pre-downloaded content. In one embodiment, the storage management module 404 can also delete pre-downloaded content at the instruction of the user.

In one embodiment, the storage management module 404 periodically refreshes the pre-downloaded content. In this configuration, the storage management module 404 tracks one or more amounts of elapsed time associated with the pre-downloaded content present on the client device 102, and uses the tracked times to selectively delete content from the client device. These tracked amounts of elapsed time are referred to as “timers,” and each pre-downloaded content item may have one or more timers tracking different time periods.

A timer may be based on events involving the content with which the timer is associated. For example, an ebook may have a timer measuring the elapsed time since the ebook was pre-downloaded to the client device 102 or since a user selected or otherwise expressed an interest in the ebook. Likewise, an ebook may have a timer based on usage of the client device 102 not directly involving the ebook with which the timer is associated. For example, an ebook may have a timer measuring elapsed time since the user purchased an ebook, since a user finished reading a particular ebook, and/or since the user started reading a particular book using the client device 102.

The storage management module 404 evaluates the content timers to determine whether to delete pre-downloaded content from the client device 102. Generally, the storage management module 404 deletes content if a particular timer surpasses a specified threshold. The thresholds can vary based on the type of timer, the content, the user, the client device 102, and/or based on other factors. For example, the storage management module 404 may delete content if the user did not purchase it and the amount of time since the content was pre-downloaded to the client device 102 surpasses a specified threshold. If the content is a sequel or otherwise related to content already consumed by the user, the storage management module 404 may delete the content if the elapsed time since the user last consumed the related content surpasses a specified threshold. Other embodiments of the storage management module 404 can use different or additional evaluations to determine whether to delete content from the client device 102.

A content activation module 406 selectively activates pre-downloaded content for consumption by the user of the client device 102. As mentioned above, the pre-downloaded content is restricted in one embodiment to prevent the user from gaining illegitimate access to the content. For example, a pre-downloaded ebook may be encrypted or otherwise obfuscated to prevent the user from accessing the ebook content. Likewise, the pre-downloaded content may be unencrypted, but inaccessible to the user due to other access restrictions enforced by the content activation module 406.

In one embodiment, the content activation module 406 interacts with the user of the client device 102 to facilitate purchase of pre-downloaded content. As used herein, “purchase” also includes other similar transactions, such as a temporary rental of the content or a license to the content. For example, the content activation module 406 may present a GUI on the display of the client device 102 that allows the user to identify a payment instrument and purchase a pre-downloaded ebook. In one embodiment, the content activation module 406 communicates with the content server 110 and/or another entity via the network 108 to perform the purchase transaction. The ebook activation module 406 provides the user with access to the pre-downloaded and purchased content upon completion of the purchase transaction.

The content activation module 406 may also implement an offline purchase scheme that allows a user to purchase pre-downloaded content when network connectivity is unavailable. For this scheme, the content activation module 406 performs the purchase transaction with the user, or at least as much of the transaction that may be performed without network connectivity, and caches (stores) the transaction data. The content activation module 406 provides the user with access to the pre-downloaded and purchased content, and subsequently settles the purchase transaction once network connectivity becomes available.

The content activation module 406 provides the user with access to the purchased pre-downloaded content. The content activation module 406 may provide this access by lifting the access restriction that prevented the user from consuming the content. For example, the content activation module 406 may download or access previously-downloaded decryption keys and decrypt the content. The content activation module 406 may also lift other restrictions that prevented the user from consuming the content. Additionally, the content activation module 406 may update the GUI of the client device 102 to reflect that the user now has access to the content. Thus, the content activation module 406 allows the user to access the pre-downloaded content without needing to download the content at the time of purchase because the content is already stored on the client device 102.

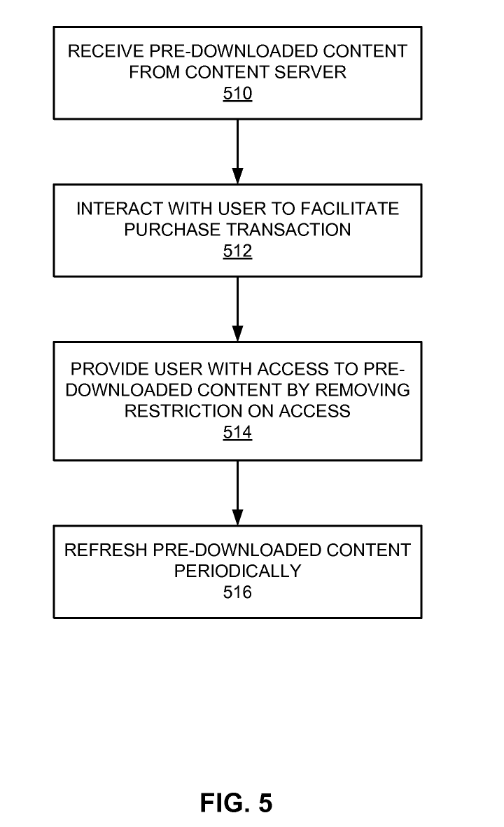

FIG. 5 is a flowchart illustrating a method of providing access to pre-downloaded content according to one embodiment. In the described embodiment, the steps of the method are performed by the client device 102. However, some or all of the steps may be performed by other entities in other embodiments. Other embodiments may also include different and/or additional steps that the ones described herein.

In step 510, the client device 102 receives pre-downloaded content from the content server 110. In one embodiment, the pre-downloading occurs at a time scheduled by the client device 102 based on scheduling conditions. For example, the client device 102 can evaluate the scheduling conditions and schedule a time to pull content from the content server 110. The client device 102 may also receive (step 510) content pushed from the content server 110. The content server 110 may likewise evaluate scheduling conditions to determine when to push content to the client device 102. The pre-downloaded content is stored at the client device 102 and access to the content is restricted to prevent the user from consuming it.

Assume for the sake of example that the user of the client device 102 desires to purchase pre-downloaded content. In step 512, the client device 102 interacts with the user to facilitate the purchase transaction. As part of this interaction, the client device 102 may identify a payment instrument used by the user for the purchase. If the client device 102 can communicate via the network 108, the client device interacts with the content server 110 and/or another entity to verify the payment instrument and complete the transaction. If the client device 102 cannot communicate via the network 108, an embodiment of the client device caches the payment instrument and treats the purchase transaction as having been completed. The client device 102 subsequently verifies the payment instrument once network communications are available. After the purchase transaction completes, in step 514, the client device 102 provides the user with access to the pre-downloaded content by removing the restriction on access. This access allows the user to consume the content. For example, the client device 102 may decrypt or otherwise de-obfuscate the content. The client device 102 may later block access to the content if is unable to verify a cached payment instrument.

Additionally, in step 516, the client device 102 periodically refreshes the pre-downloaded content. In one embodiment, the client device 102 maintains one or more timers for each pre-downloaded content item. A timer measures time elapsed since the occurrence of an event such as the pre-downloading of the content, a purchase by the user, and/or the user expressing an interest in particular content. The client device 102 evaluates the timers and may delete pre-downloaded content from the client device based on the evaluation. Deleting the pre-downloaded content makes space for new content to be downloaded, and thus allows for the pre-downloaded content to be refreshed.

The foregoing description of embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

1. A computer-implemented method of pre-downloading content to a client device used by user, comprising:
receiving pre-downloaded content at the client device via a network, the pre-downloaded content stored at the client device and having an access restriction preventing the user from consuming the pre-downloaded content;
interacting with the user of the client device to facilitate a purchase transaction for the content pre-downloaded to the client device; and
responsive to the purchase transaction, removing the access restriction to allow the user to consume the pre-downloaded content at the client.

2. The method of claim 1, wherein receiving the pre-downloaded content comprises:
evaluating scheduling conditions associated with the client device to schedule a time to retrieve content from a content server; and
retrieving the content as the pre-downloaded media content from the content server at the scheduled time.

3. The method of claim 1, wherein receiving the pre-downloaded content comprises:
receiving information describing content available for pre-download;
selecting content from among the described content; and
pre-downloading the selected content.

4. The method of claim 3, wherein the received information describing content available for pre-download comprises a list of content ranked in an order determined responsive at least in part to a likelihood that the user will purchase the content and wherein selecting content from among the described content comprises selecting content from among the content in the list.

5. The method of claim 1, wherein interacting with the user of the client device to facilitate a purchase transaction for the content pre-downloaded to the client device comprises:
identifying a payment instrument to be used by the user to purchase the pre-downloaded content; and
performing the purchase transaction for the pre-downloaded content using the payment instrument.

6. The method of claim 1, further comprising:
maintaining one or more timers for the pre-downloaded content, a timer measuring time elapsed since an event associated with the content;
evaluating the timers for the pre-downloaded content; and
selectively deleting the pre-downloaded content from the client device responsive to the evaluation.

7. The method of claim 1, wherein the pre-downloaded content comprises an encrypted electronic book (ebook) that the user has not explicitly expressed an interest in obtaining, the encrypted ebook is stored at the client device prior to the purchase transaction, and removing the access restriction comprises receiving a corresponding decryption key from a content server and decrypting the ebook to allow the user to read the ebook.

8. A non-transitory computer-readable storage medium storing executable computer program instructions for pre-downloading content to a client device used by user, the computer program instructions comprising instructions for:
receiving pre-downloaded content at the client device via a network, the pre-downloaded content stored at the client device and having an access restriction preventing the user from consuming the pre-downloaded content;
interacting with the user of the client device to facilitate a purchase transaction for the content pre-downloaded to the client device; and
responsive to the purchase transaction, removing the access restriction to allow the user to consume the pre-downloaded content at the client.

9. The storage medium of claim 8, wherein receiving the pre-downloaded content comprises:
evaluating scheduling conditions associated with the client device to schedule a time to retrieve content from a content server; and
retrieving the content as the pre-downloaded media content from the content server at the scheduled time.

10. The storage medium of claim 8, wherein receiving the pre-downloaded content comprises:
receiving information describing content available for pre-download;
selecting content from among the described content; and
pre-downloading the selected content.

11. The storage medium of claim 10, wherein the received information describing content available for pre-download comprises a list of content ranked in an order determined responsive at least in part to a likelihood that the user will purchase the content and wherein selecting content from among the described content comprises selecting content from among the content in the list.

12. The storage medium of claim 8, wherein interacting with the user of the client device to facilitate a purchase transaction for the content pre-downloaded to the client device comprises:
identifying a payment instrument to be used by the user to purchase the pre-downloaded content; and
performing the purchase transaction for the pre-downloaded content using the payment instrument.

13. The storage medium of claim 8, wherein the computer program instructions further comprise instructions for:
maintaining one or more timers for the pre-downloaded content, a timer measuring time elapsed since an event associated with the content;
evaluating the timers for the pre-downloaded content; and
selectively deleting the pre-downloaded content from the client device responsive to the evaluation.

14. The storage medium of claim 8, wherein the pre-downloaded content comprises an encrypted electronic book (ebook) that the user has not explicitly expressed an interest in obtaining, the encrypted ebook is stored at the client device prior to the purchase transaction, and removing the access restriction comprises receiving a corresponding decryption key from a content server and decrypting the ebook to allow the user to read the ebook.

15. A computer system for pre-downloading content to a client device used by user, comprising:
a non-transitory computer readable storage medium storing executable program code comprising code for:
receiving pre-downloaded content at the client device via a network, the pre-downloaded content stored at the client device and having an access restriction preventing the user from consuming the pre-downloaded content;
interacting with the user of the client device to facilitate a purchase transaction for the content pre-downloaded to the client device; and
responsive to the purchase transaction, removing the access restriction to allow the user to consume the pre-downloaded content at the client; and
a processor for executing the program code.

16. The system of claim 15, wherein receiving the pre-downloaded content comprises:
evaluating scheduling conditions associated with the client device to schedule a time to retrieve content from a content server; and
retrieving the content as the pre-downloaded media content from the content server at the scheduled time.

17. The system of claim 15, wherein receiving the pre-downloaded content comprises:
receiving information describing content available for pre-download;
selecting content from among the described content; and
pre-downloading the selected content.

18. The system of claim 17, wherein the received information describing content available for pre-download comprises a list of content ranked in an order determined responsive at least in part to a likelihood that the user will purchase the content and wherein selecting content from among the described content comprises selecting content from among the content in the list.

19. The system of claim 15, wherein the executable program code further comprises code for:
maintaining one or more timers for the pre-downloaded content, a timer measuring time elapsed since an event associated with the content;
evaluating the timers for the pre-downloaded content; and
selectively deleting the pre-downloaded content from the client device responsive to the evaluation.

20. The system of claim 15, wherein the pre-downloaded content comprises an encrypted electronic book (ebook) that the user has not explicitly expressed an interest in obtaining, the encrypted ebook is stored at the client device prior to the purchase transaction, and removing the access restriction comprises receiving a corresponding decryption key from a content server and decrypting the ebook to allow the user to read the ebook.
